(19) United States
(12) Patent Application Publication
(10) Pub. No.: US 2013/0341873 A1
(43) Pub. Date: Dec. 26, 2013

(54) Radial Shaft Seal Ring

(71) Applicants: Helmut Benedix, Leichlingen--Witzfeld (DE); Juergen Netzer, Burscheid (DE); Christoph Passow, Leichlingen (DE)

(72) Inventors: Helmut Benedix, Leichlingen--Witzfeld (DE); Juergen Netzer, Burscheid (DE); Christoph Passow, Leichlingen (DE)

(21) Appl. No.: 13/978,561

(22) PCT Filed: Dec. 12, 2011
(86) PCT No.: PCT/EP2011/072436

§ 371 Date: Sep. 16, 2013

(30) Foreign Application Priority Data
Jan. 11, 2011 (DE) 102011002491.3

(51) Int. Cl. F16J 15/32

(52) U.S. Cl. CPC F16J 15/32
USPC 277/561

(57) ABSTRACT

A radial shaft seal ring includes a reinforcement ring and an elastomeric part connected to the reinforcement ring. The elastomeric part carries a sealing lip, which is formed by an annular component connected to the elastomeric part. The annular component has a sealing edge made from PTFE which is formed to sealingly abut on a shaft to be sealed by the radial shaft seal ring. The sealing edge can be formed as a sharp-edged sealing edge that abuts, in linear contact, on the to-be-sealed shaft.

The invention relates to a radial shaft seal ring, including a reinforcement ring and an elastomeric part connected to the reinforcement ring, which elastomeric part carries a dynamic sealing lip.

DE 10 2007 036 625 A1 describes a sealing element for sealing a shaft, provided for rotating in accordance with its design, at a through-opening of a housing part for the shaft. The sealing element includes a reinforcement part and an elastomeric part connected to the reinforcement part. The elastomeric part comprises a first sealing section for a static sealing abutment on the housing part, and the elastomeric part comprises a second sealing section having a sealing segment formed and provided for sealing abutment on the shaft, which sealing segment comprises a thread-like return structure for a return of a leaked fluid into a to-be-sealed chamber, and a free axial end of the sealing segment abutting on the shaft in accordance with its design is formed with a closed line in the circumferential direction and extending on a circular-cylinder outer surface, which line is provided for sealing abutment on the shaft at least when the shaft is not rotating.

It is an object of the invention to provide a radial shaft seal ring having improved running and/or sealing properties.

The object of the invention is achieved by a radial shaft seal ring including a reinforcement ring and an elastomeric part connected to the reinforcement ring, which elastomeric part carries a sealing lip, which is formed by an annular component connected to the elastomeric part, which annular component has a sealing edge made from PTFE which is formed to sealingly abut on a shaft to be sealed by the radial shaft seal ring. The sealing edge can be formed as a sharp-edged sealing edge abutting, in linear contact, on the to-be-sealed shaft. Alternatively the sealing edge can be formed as a sealing surface flatly abutting on the to-be-sealed shaft, in particular an annular inner surface.

The annular component can also be referred to as a sleeve-shaped body. The annular component or the sleeve-shaped body can have here a higher rigidity and/or strength than the elastomeric part. The annular component can in this respect be formed from a hollow circular-cylinder segment, which has an inner surface wall, on which the sealing edge made of polytetrafluoroethylene (PTFE) is attached. Instead of a single sealing edge, a plurality of sealing edges made of polytetrafluoroethylene (PTFE) can be provided. The single sealing edge or the plurality of sealing edges can form a thread-like return structure, for example for oil.

The annular component can be made from a non-elastomeric material in the shape of a hollow circular-cylinder segment, which is connected to the elastomeric part, in particular vulcanized to the elastomeric part, and whose inner surface wall includes the sealing edge made from PTFE. For a good connection of the annular component to the elastomeric part, the annular component can have a chamfered, in particular conical, end side, which has a contact surface for vulcanizing to the elastomeric part.

The elastomeric part can include a radial sealing lip section and an axial sealing lip section, and the annular component can be connected to the axial sealing lip section.

The annular component can be made of PTFE. The annular component can in particular be made entirely of PTFE. The annular component and the sealing edge can be manufactured in a one-piece manner from PTFE.

The elastomeric part can include a static sealing lip. The static sealing lip is adapted to the annular component or to the sealing edge made of PTFE in its shape, arrangement and size, i.e. matched to the annular component or the sealing edge made of PTFE.

The static sealing lip can by formed by an inwardly-projecting annular bead on an axial sealing lip section of the elastomeric part. The static sealing lip, in particular the annular bead, can have a smaller inner diameter than the sealing edge of the dynamic sealing lip. This means that the static sealing lip also projects inward beyond the sealing edge of the dynamic sealing lip, i.e. projects radially towards a to-be-sealed shaft. The static sealing lip can have a semicircular shape in cross-section.

The static sealing lip can be located on the axial sealing lip section in the vicinity of an arc-shaped transition region to the radial sealing lip section.

In all embodiments of the radial shaft seal ring, the static sealing lip can be manufactured in a one-piece manner with a membrane connection. The membrane connection can be formed by the transition section between an axial and a radial sealing lip segment.

In summary, the invention can, sometimes in other words, thus provide a solution in particular for friction-optimized PTFE seals.

PTFE materials are generally less flexible than elastomeric materials, and for reliable functioning in radial shaft seal rings in tolerance margins, must be designed with relatively high contact forces. Such a rigid design can have increased friction losses as a consequence. In addition, PTFE materials are in principle likely not gas-tight, so that for example during a final assembly inspection of the radial shaft seal ring, in particular during a gas-tightness inspection, it can lead to undesirable gas leaks, which must be contained by forming additional sealing means thereon.

In various motors which include radial shaft seal rings, PTFE seal rings are therefore sometimes replaced by similarly-designed elastomeric shaft seal rings. Elastomeric shaft seal rings are, however, generally less pressure-stable in application.

The sealing lip can be made in an inventive manner from a sleeve-shaped PTFE body, i.e. from an annular component, which is connected to a reinforcement ring via a flexible elastomeric membrane, i.e. an elastomeric part of the radial shaft seal ring. An additional static sealing ridge, i.e. a static sealing lip having only very little overlap can be attached to the shaft in the elastomeric membrane, which additional static sealing ridge undertakes the sealing for example in a gas-tightness test. The PTFE sealing body can be designed with low contact force, since the elastomeric membrane can, due to its higher flexibility or elasticity, in large part undertake a compensation of manufacturing tolerances. The coefficients of friction of the seal can thereby be further optimized. A static seal can be integrated in the radial shaft seal ring for gas-tightness tests. Advantages can result with respect to material costs and costs of a PTFE activation.

Two exemplary embodiments of the invention are illustrated in the appended schematic drawings in an exemplary manner.

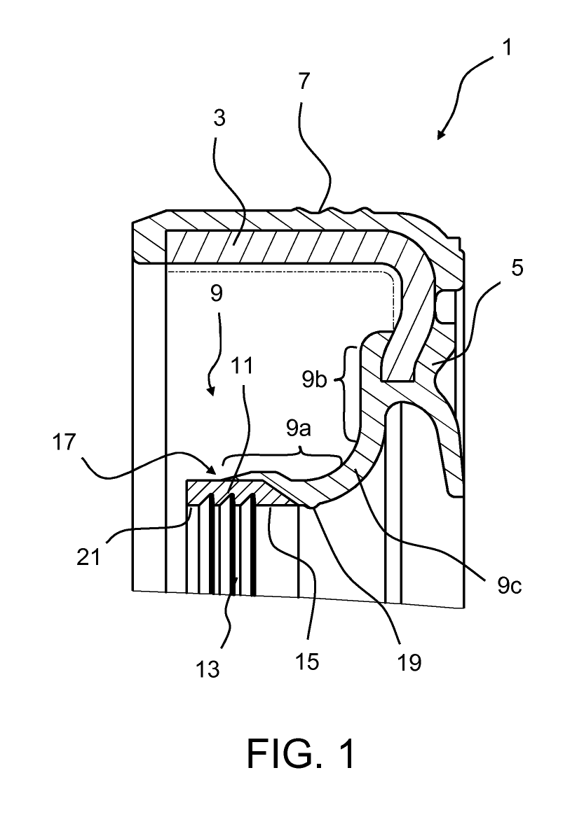

FIG. 1 shows a longitudinal section through a segment of the upper half of a radial shaft seal ring including an exemplary embodiment of an inventive annular component,

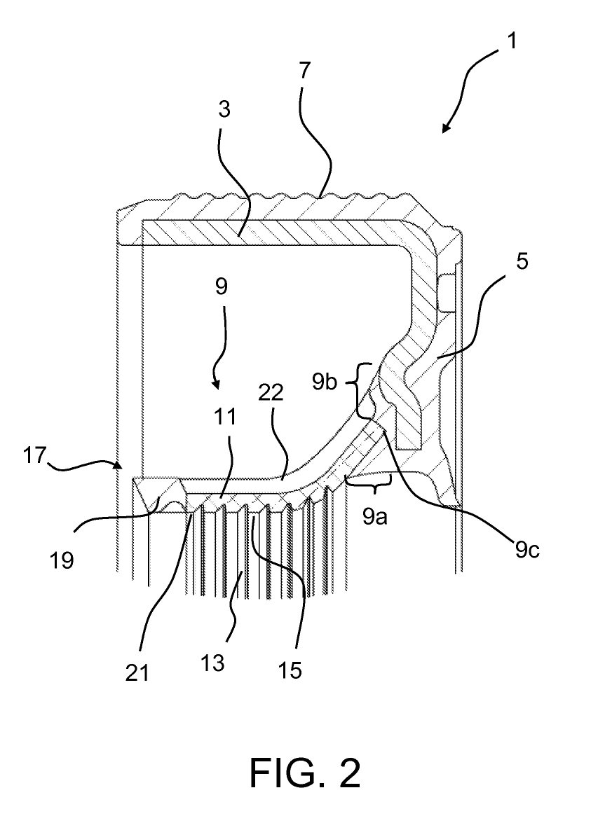

FIG. 2 shows a longitudinal section through a segment of the upper half of a radial shaft seal ring including an alternative embodiment of an inventive annular component.

FIG. 1 shows, as an exemplary embodiment of the invention, a longitudinal section through a segment of the upper half of a radial shaft seal ring 1. Here the radial shaft seal ring 1 includes a reinforcement ring 3 as well as a one-piece-formed elastomeric part 5 connected to the reinforcement ring 3. The reinforcement ring 3 here is manufactured for example from a metal plate. The elastomeric part 5 is connected to the reinforcement ring 3 by a vulcanization with it.

The elastomeric part 5 has a static sealing region 7, whose outer surface is formed for static sealing abutment on a not-shown housing part in the region of a through-opening, for example of a housing, for a to-be-sealed, also not-shown, shaft.

The elastomeric part 5 has a sealing lip 9, which abuts on the not-shown shaft when the radial shaft seal ring 1 is installed in accordance with its design. The sealing lip 9 includes an annular component 11. The sealing lip 9 can in particular include an annular component 11, which before installation on the shaft preferably has a cone shape having an angle between 5° and 30°. This annular component 11 is provided with a thread-like return structure 13. The thread-like return structure 13 is illustrated greatly exaggerated in FIG. 1. Instead of the three revolutions of passages shown, the return structure 13 can also have more than three passages. The pitch of the passages is actually much smaller than illustrated. The pitch of the passages can for example be 0.2 or 1.0 mm.

At a free end 17 of an axial sealing lip section 9a, the sealing lip 9 carries the annular component 11.

As illustrated in the exemplary embodiment of FIG. 1, the dynamic sealing lip 9 includes an axial sealing lip section 9a and a radial sealing lip section 9b. The axial sealing lip section 9a has a sealing edge 21 for a sealing abutment on a shaft, which sealing edge 21 is disposed on the inner surface wall 15 of the axial sealing lip section 9a, which inner surface wall 15 faces towards the shaft.

The axial direction refers here to the axial extension of the shaft or of the shaft axis. This also means that the axial direction refers to the axial extension of the hollow cylindrical axial sealing lip section 9a. This axial extension corresponds here to the rotational axis of the hollow cylindrical basic shape of the axial sealing lip section 9a. Based on the hollow cylindrical basic shape of the axial sealing lip section 9a, the references to the inner surface wall 15 of the annular component 11 also result.

In the exemplary embodiment, the axial sealing lip section 9a is manufactured from an elastomer. A sealing edge 21 made of polytetrafluoroethylene (PTFE) is attached to a free end 17 of the elastomeric axial sealing lip section 9a. The sealing edge 21 made from polytetrafluoroethylene (PTFE) is formed here on an inner surface wall 15 of the annular component 11. In the exemplary embodiment, the annular component 11 is formed one-piece with the sealing edge 21. The annular component 11 and the sealing edge 21 are in this respect both commonly made of polytetrafluoroethylene (PTFE). The annular component 11 is vulcanized to the elastomeric axial sealing lip section 9a of the elastomeric part 9.

The elastomeric part 5, in particular of the axial sealing lip section 9a, includes a static sealing lip 19. In the exemplary embodiment shown, the static sealing lip 19 is formed by an inwardly-projecting annular bead on the axial sealing lip section 9a of the elastomeric part 5. The static sealing lip 19 is located on the axial sealing lip section 9a in the vicinity of an arc-shaped transition region of a membrane connection 9c to the radial sealing lip section 9b.

The static sealing lip 19, in particular the annular bead, has a smaller inner diameter than the sealing edge 21 of the dynamic sealing lip 9. This means that the static sealing lip 19 also projects inward beyond the sealing edge 21 of the dynamic sealing lip 9, i.e. radially towards a to-be-sealed shaft. The static sealing lip 19 can have a semicircular shape in cross-section.

Alternatively, as illustrated in the exemplary embodiment of FIG. 2, the static sealing lip 19 can also be attached to the end side of the sealing edge 21. Moreover, in the alternative embodiment according to FIG. 2, the static sealing lip 19 can be connected in particular in a one-piece manner to the axial sealing lip section 9a and/or, as illustrated in FIG. 2, to the radial sealing lip section 9b via one or a plurality of elastomeric bridges 22, in particular thin in axial cross-section, axial-extending, elastomeric bridges 22 distributed on an outer circumference of the annular component 11.

### REFERENCE NUMBER LIST

1 Radial shaft seal ring
3 Reinforcement ring
5 Elastomeric part
7 Static sealing region
9 Sealing lip
9a Axial sealing lip section
9b Radial sealing lip section
9c Membrane connection
11 Annular component
13 Return structure
15 Surface wall
17 Free end
19 Static sealing lip
21 Sealing edge
22 Elastomeric bridges

1.-9. (canceled)

10. A radial shaft seal comprising:
a reinforcement ring,
an elastomeric part including a radial sealing lip section connected to an axial sealing lip section, the reinforcement ring being connected to the radial sealing lip section, and
a dynamic sealing lip including an annular component connected to the axial sealing lip section,
wherein the annular component has a sealing edge made of PTFE that is configured to sealingly abut on a shaft to be sealed by the radial shaft seal, and
the annular component at least partially axially overlaps the axial sealing lip section.

11. The radial shaft seal according to claim 10, wherein:
the annular component is comprises a non-elastomeric material and is formed in the shape of a hollow circular-cylinder segment,
the hollow circular-cylinder segment is connected to the elastomeric part,
an inner surface wall of the hollow circular-cylinder segment includes the sealing edge made from PTFE.

12. The radial shaft seal according to claim 11, wherein the hollow circular-cylinder segment is vulcanized to the elastomeric part.

13. The radial shaft seal according to claim 12, wherein the sealing edge has a thread-shaped return structure with at least three revolutions of passages.

14. The radial shaft seal according to claim 13, wherein the entire annular component is made of PTFE.

15. The radial shaft seal according to claim 14, wherein the annular component and the sealing edge are integrally formed of PTFE without a seam therebetween.

16. The radial shaft seal according to claim 15, wherein the elastomeric part further includes a static sealing lip.

17. The radial shaft seal according to claim 16, wherein the static sealing lip is formed as a radially-inwardly-projecting annular bead disposed on the axial sealing lip section of the elastomeric part.

18. The radial shaft seal according to claim 17, wherein a radially-innermost surface of the annular bead has a smaller inner diameter than a radially-innermost surface of the sealing edge of the dynamic sealing lip.

19. The radial shaft seal according to claim 18, wherein the static sealing lip is integrally formed with a membrane connection that connects the radial sealing lip section to the axial sealing lip section.

20. The radial shaft seal according to claim 19, wherein the annular component has a cone-shaped end surface connected to the axial sealing lip section.

21. The radial shaft seal according to claim 10, wherein the sealing edge has a thread-shaped return structure with at least three revolutions of passages.

22. The radial shaft seal according to claim 10, wherein the elastomeric part further includes a static sealing lip.

23. The radial shaft seal according to claim 22, wherein the static sealing lip is formed as a radially-inwardly-projecting annular bead disposed on the axial sealing lip section of the elastomeric part.

24. The radial shaft seal according to claim 22, wherein a radially-innermost surface of the static sealing lip has a smaller inner diameter than a radially-innermost surface of the sealing edge of the dynamic sealing lip.

25. The radial shaft seal according to claim 22, wherein the static sealing lip is integrally formed with an elastomeric membrane connection that connects the radial sealing lip section to the axial sealing lip section.

26. The radial shaft seal according to claim 22, wherein the static sealing lip has a semicircular shape in cross-section.

27. The radial shaft seal according to claim 10, wherein the reinforcing ring is comprised of metal and the radial sealing lip section is vulcanized to the reinforcement ring.

28. The radial shaft seal according to claim 10, further comprising a static sealing segment disposed on a radially outer surface of the reinforcement ring.
